(19) United States
(12) Patent Application Publication
(10) Pub. No.: US 2004/0165001 A1
(43) Pub. Date: Aug. 26, 2004

(54) Color temperature automatic adjusting device and the method for performed the same

(76) Inventor: Jui-Ming Wang, Taipei Hsien (TW)

Correspondence Address: Jui-Ming Wang, 235 Chung - Ho, Box 8-24, Taipei, TW

(21) Appl. No.: 10/448,382

(22) Filed: May 30, 2003

(30) Foreign Application Priority Data
Feb. 21, 2003 (TW) 092103709

(51) Int. Cl. G09G 5/10; H04N 9/73

(52) U.S. Cl. 345/690; 348/655

(57) ABSTRACT

A color temperature automatic adjusting device comprises a connecting device for inputting or output signals; a signal conversion device for converting into analog signals into digital signals; a central processing unit for programming fonts and formats of the data shown on the display device; a display control device for controlling frame size quality and illumination; a display control device for displaying image and message; a color temperature sensing device for sensing color temperature value and outputting the value; a calculator for operating the output data and outputting the data; and a signal connecting wire for connecting an output of the calculator to the connecting device Also, a color temperature automatic adjusting method is disclosed.

### FIELD OF THE INVENTION

The present invention relates to a color temperature automatic adjusting device and a method for performed the same. In the present invention, the adjustment of the color temperature value is performed automatically and thus a higher precision is achieved,

### BACKGROUND OF THE INVENTION

The color feelings of eyes are dependent of the colors of eyes, for example, blue eyes or brown eyes. The blue eyes are sensitive to weak lights, while the brown eyes are sensitive to strong lights.

Thereby, in manufacturing a display, it is necessary to adjust the color temperature value of the display. The color temperature value is due to black body effect. Since the radiation of an object is dependent on the heat radiation, the temperature of a body will effect the radiate different lights, this is what we called color temperature. Low color temperatures means lights near yellow or red light and high color temperature means lights near blue lights. In general-, standard color temperature is 5000K and thus a display must be adjusted to 5000K. In general, the color temperature of a display is adjusted in the manufacturing process from the OSD adjusting key and then a color temperature sensing device is used to detect the color temperature value externally. Then, the user provides a standard color temperature value to the manufacturer for correcting the color temperature value of the display by worker's eyes., However this prior art way has the following defects.

Firstly, errors are induced from OSD keys since there are too many components in the display and the operation variation of the operator

Secondary, the variations of different operators still induce that the adjusted color temperature values are not uniform, it is affected by the experience and visual feeling of the operator.

Thirdly, if too many displays is necessary to be adjusted, the operator will be tired and can not adjust to an uniform color temperature value.

### SUMMARY OF THE INVENTION

Accordingly, the primary object of the present invention is to provide a color temperature automatic adjusting device comprising a connecting device for inputting or output signals; a signal conversion device for converting into analog signals into digital signals; a central processing unit for programming fonts and formats of the data shown on the display device; a display control device for controlling frame size, quality and illumination; a display control device for displaying image and message; a color temperature sensing device for sensing color temperature value and outputting the values a calculator for operating the output data and outputting the data; and a signal connecting wire for connecting an output of the calculator to the connecting device.

Another object of the present invention is to provide a color temperature automatic adjusting method which comprises the step of moving a color temperature sensing end of a color temperature sensing device to be near the display device for sensing the color temperature of the display device; displaying the measured color temperature value real time by numeral display and outputting the color temperature value; a calculator receiving signals from an output end of the color temperature sensing device; displaying the color temperature value received from the calculator by a calculator display; inputting standard color temperature values to the calculator; in the calculator; comparing the color temperature value from the calculator with the standard color temperature values so as to get a difference which is an analog VGB signal; sending the difference to the connecting device through a signal connecting wire; transferring difference to the signal conversion device for converting the analog RGB signals into digital signals transferring the converted digital signal to the central processing unit for controlling the size, quality and illumination of the display frame based on the converted digital signal; sending the output of the central processing unit to the display control device for defining the display frame and controlling the OSD display sub-frame and the font of displaying characters; and repeating about process so that the adjust the output of the display device to be matched to the setting inputted to the calculator.

The various objects and advantages of the present invention will be more readily understood from the following detailed description when read in conjunction with the appended drawing.

### BRIEF DESCRIPTION OF THE DRAWINGS

FIG. 1 shows the block diagram of the present invention.

FIG. 2 shows the structure of the color temperature sensing device of the present invention.

FIG. 3 shows the structure of the color temperature sensing device and locking hole of the present invention.

FIG. 4 shows the connection of the signal conversion device, central processing unit and display control device according to the present invention.

FIG. 5 shows the hardware structure of the present invention.

### DETAILED DESCRIPTION OF THE PREFERRED EMBODIMENTS

In the following, the present invention will be described, however the following description is only the embodiment of the present invention which can not be used to confine the scope of the present invention. Thus, all the modification and variation of the embodiment are within the scope of the present invention.

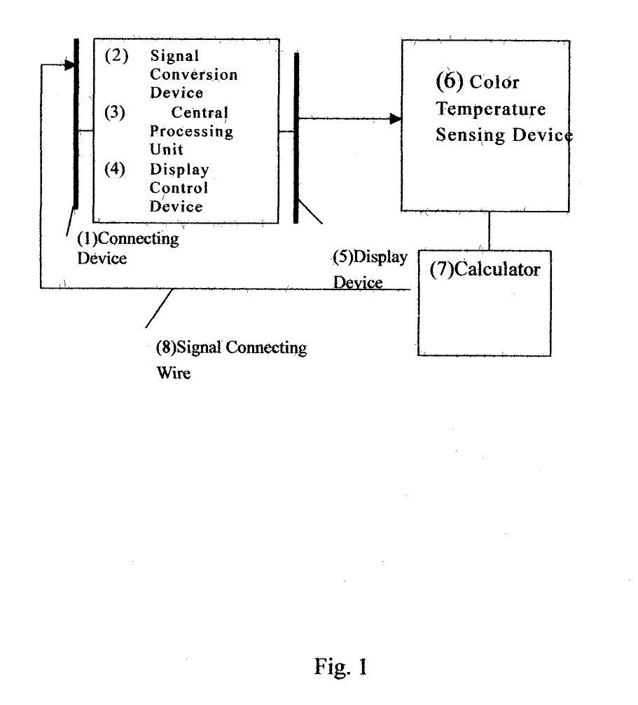

Referring to, FIG. 1, in the present invention, the color temperature automatic adjusting device of the present invention includes a connecting device 1 for inputting or output signals a signal conversion device 2 for converting into analog signals into digital signals; a central processing unit for programming fonts and formats of the data shown on the display de vice; a display control device 4 for controlling frame size, quality and illumination; a display control device 4 for displaying image and message; a color temperature sensing device 6 for sensing color temperature value and outputting the value; a calculator 7 for operating the output data′ and outputting the data; and a signal connecting wire 8 for connecting an output of the calculator 7 to the connecting device 1.

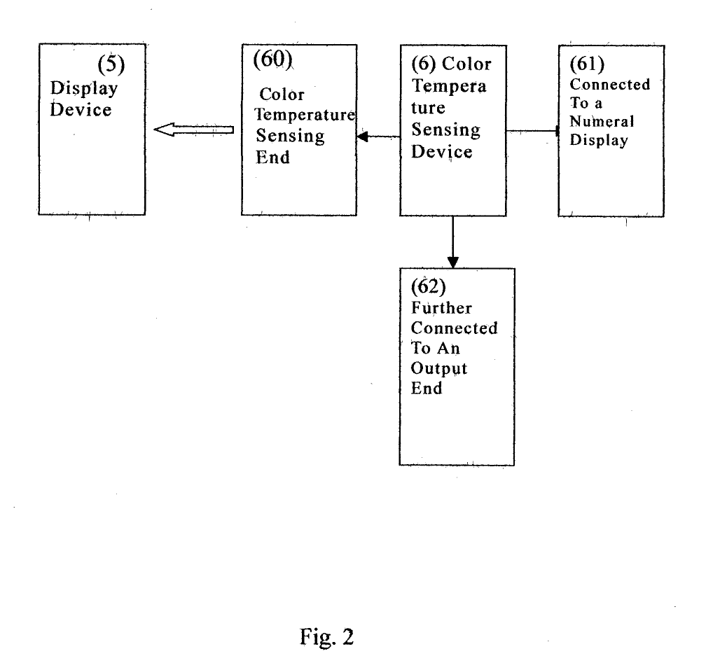

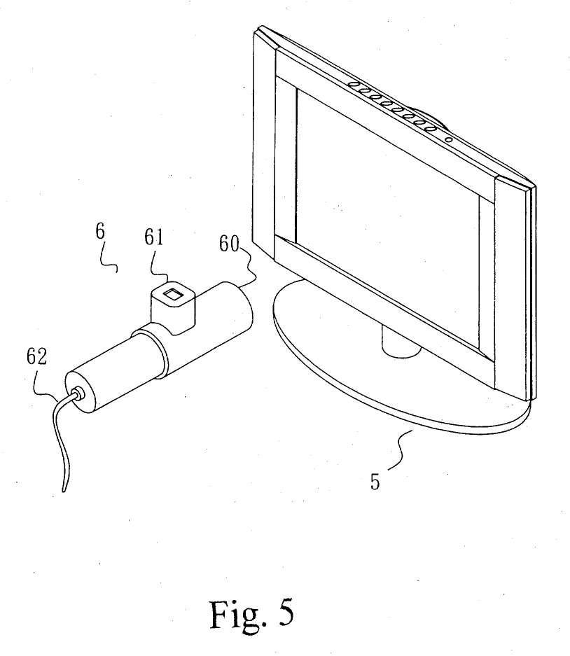

With reference to FIGS. 2 and 5, it is illustrated that the display device 5 is connected to the color temperature sensing device 6. A color temperature sensing end 60 is placed between the display control device 4 and the color temperature sensing device 6. In use it is only necessary to move the color temperature sensing end 60 to be near the display device 5 for sensing the color temperature of the display device 5. The color temperature sensing device 6 is further connected to a numeral display 61 for displaying the measured color temperature value real time. The color temperature sensing device 6 is further connected to an output end 62 for transferring the color temperature value to the calculator 7.

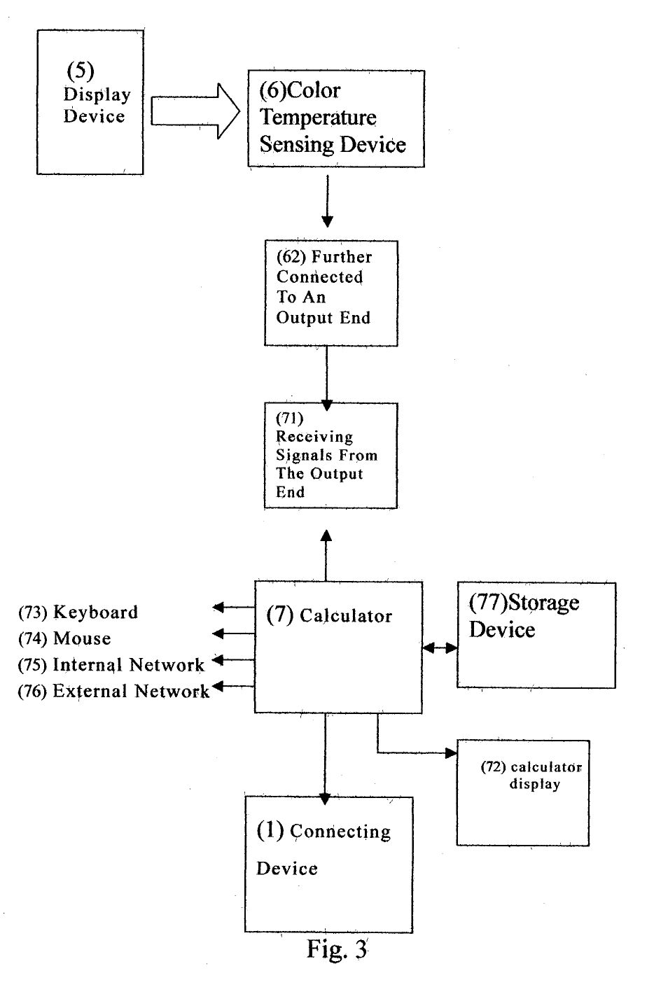

Referring to FIG. 3, the calculator 7 has an input end 71 for receiving signals from the output end 62 of the color temperature sensing device 6. The calculator 7 has a calculator display 72 for displaying the color temperature value received by the input end 71 of the calculator 7. The calculator 7 can be connected to other input devices, such as a keyboard 73, a mouse 74, an internal network 75 or an external network 76 for inputting a standard color temperature value to the calculator 7. The calculator 7 compares the color temperature value from the input device 71 of the calculator 7 with the standard color temperature value from other input device so as to get a difference. The difference is further provided to the connecting device 1 through the signal connecting wire 8.

Referring to FIG. 2, it is illustrated that the difference value provided by the calculator 7 to the connecting device 1 through the signal connecting wire 8. The signals are analog RGB (red, green, and blue signals). Then the analog signals are transferred to the signal conversion device 2. The signal conversion device 2 is an analog to digital converter for converting the analog RGB signals into digital signals.

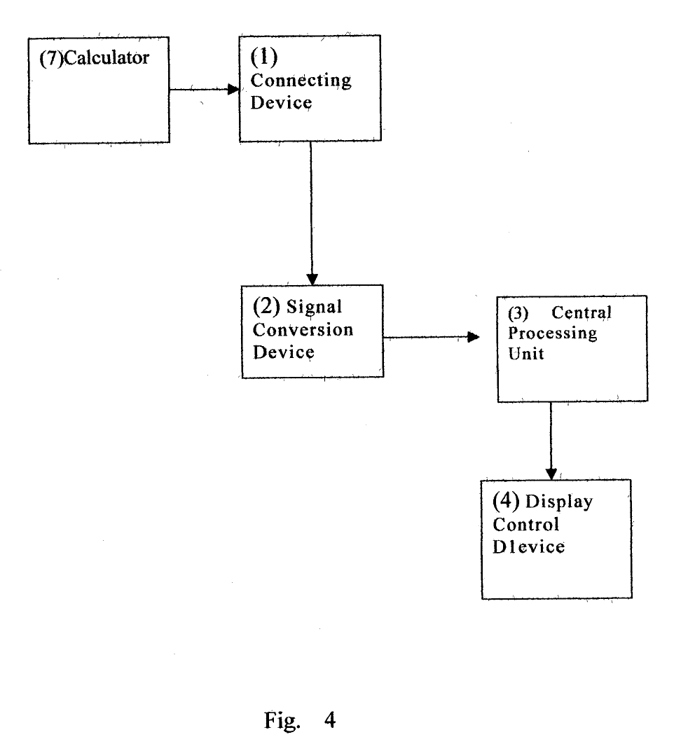

Referring to FIG. 4, then the converted digital signals are transferred to the central processing unit 3, in one embodiment, which is a SCALER IC (3). The central processing unit 3 serves to control a driving IC in the display device 5 for controlling the size, quality and illumination of the display frame. Then the difference values are added to the pixels of display frame. Thereby, the output of the display device 5 is matched to the color temperature values set in to the calculator 7.

The output of the central processing unit 3 is sent to the display control device 4. The display control device 4 can define the display frame and control the OSD display sub-frame and the font of displaying characters which can be adjusted according to the requirement of the user. Then the result of the display control device 4 is outputted to the display device 5.

About said process is repeated so that the adjust the output of the display device 5 to be matched to the setting inputted to the calculator 7.

Thereby, the color temperature automatic adjusting method of the present invention comprises the step of moving a color temperature sensing end of a color temperature sensing device to be near the display device for sensing the color temperature of the display device; displaying the measured color temperature value real time by numeral display and outputting the color temperature value; a calculator receiving signals from an output end of the color temperature sensing device; displaying the color temperature value received from the calculator by a calculator display; inputting standard color temperature values to the calculator; in the, calculator; comparing the color temperature value from the calculator with the standard color temperature values so as to, get a difference which is an analog RGB signal; sending the difference to the connecting device through a signal connecting wire; transferring difference to the signal conversion device for converting the analog RGB signals into digital signals; transferring the converted digital signal to the central processing unit for controlling the size, quality and illumination of the display frame based on the converted digital signal; sending the output of the central processing unit to the display control device for defining the display frame and controlling the OSD display sub-frame and the font of displaying characters; and repeating about process go that the adjust the output of the display device to be matched to, the setting inputted to the calculator.

Advantages of the present invention will be described herein.

At first, the color temperature values-are at an acceptable value so that one aside the display device 5 will not be harmed due to improper color temperature value, especially, the damage to the eyes.

Secondary, conventionally, in a, manufacturing line, the worker must-adjust the OSD keys and measure the color temperature value. As a result, two working process is necessary. However by the present invention, the process of measuring the color temperature value is neglected.

Thirdly, the error is induced by manually adjusting the color temperature value. However by the present invention, the adjustment of the color temperature value is performed automatically and thus a higher precision is achieved.

Fourthly, because of too many elements in a display, error is induced, while in the present invention, by the automatic adjustment, the quality is improved.

The present invention is thus described, it will be obvious that the same may be varied in many ways. Such variations are not to be regarded as a departure from the spirit and scope of the present invention, and all such modifications-as would be obvious to one skilled in the art are in tended to be included within the scope of the following-claims.

What is claimed is:

1. A color temperature automatic adjusting device comprising
a connecting device for inputting or output signals; a signal conversion device for converting into analog signals into digital signals;
a central processing unit for programming fonts and formats of the data shown on the display device a display control device for controlling frame size, quality and illumination;
a display control device for displaying image and message;
a color temperature sensing device for sensing color temperature value and outputting the value;
a calculator for operating the output data and outputting the data; and
a signal connecting wire for connecting an output of the calculator to the connecting device.

2. The color temperature automatic adjusting method as claimed in claim 1, wherein the connecting device is selected from¹ one of a data bus, a universal serial bus, a digital video interface, and an audio video interface.

3. The color temperature automatic adjusting device as claimed in claim 1, wherein the display device is selected from one of a cathode ray tube, a liquid crystal display panel, a plasma display panel (PDP™).

4. The color temperature automatic adjusting device as claimed in claim 1, wherein the connecting device, signal conversion device, central processing unit, display control device and display device are formed into a display.

5. The color temperature automatic adjusting method as claimed in claim 1, wherein color temperature value is independent from the display device and calculator.

6. The as claimed in claim 1, wherein the calculator is a personal computer.

7. The color temperature automatic adjusting method as claimed in claim 1, wherein the signal connecting wire is a wire used for one of a data bus, a universal serial bus, a digital video interface, and an audio/video interface.

8. A color temperature automatic adjusting method comprising the steps of:
moving a color temperature sensing end of a color temperature sensing device to be near the display device for sensing the color temperature of the display device;
displaying the measured color temperature value real time by numeral display and outputting the color temperature value;
a calculator receiving signals from an output end of the color temperature sensing device;
displaying the color temperature value received from the calculator by a calculator display;
inputting standard color temperature values to the calculator; in the calculator;
comparing the color temperature value from the calculator with the standard color temperature values so as to get a difference which is an analog RGB signal;
sending the difference to the connecting device through a signal connecting wire;
transferring difference to the signal conversion device for converting the analog RGB signals into digital signals;
transferring the converted digital signal to the central processing unit for controlling the size, quality and illumination of the display frame based on the converted digital signal;
sending the output of the central processing unit to the display control device for defining the display frame and controlling the OSD display sub-frame and the font of displaying characters; and repeating about process so that the adjust the output of the display device to be matched to the setting inputted to the calculator.
